(19) United States
(12) Patent Application Publication
(10) Pub. No.: US 2004/0202268 A1
(43) Pub. Date: Oct. 14, 2004

(54) Data rate acquisition using signal edges

(76) Inventors: Michael Angelo Rauber, Passail (AT); Werner Mair, Weinitzen (AT); Heinz Lanzenberger, Graz (AT)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/484,423

(22) PCT Filed: Jul. 19, 2002
(86) PCT No.: PCT/IB02/03027

(30) Foreign Application Priority Data
Jul. 20, 2001 (EP) 01890214.8

(51) Int. Cl. H04L 7/02

(52) U.S. Cl. 375/360

(57) ABSTRACT

In a method for detecting a varying data rate in a data signal, with which data signal a bit is transmitted in the form of a signal edge generated at a particular nominal time, after triggering by an interrupt signal (IS) generated in an analog/digital converter (13), the times of occurrence (TA, TB, TC, TD) of the signal edges are detected and subsequently the edge intervals (T1, T2) determined from the times of occurrence (TA, TB, TC, TD) of the signal edges and subsequently the mean edge interval (Tm) determined from the determined edge intervals (T1, T2). From the mean edge interval (Tm) and a tolerance range of the mean edge interval (Tm) are determined an upper time of occurrence limit (OAZ) and a lower time of occurrence limit (UAZ), within which upper and lower time of occurrence limit a subsequent signal edge must occur in order to be valid for the detection of a current data rate from the mean edge interval (Tm).

The invention relates to a method for detecting a data rate in a data signal of an asynchronous data transmission system, in which system a bit is transmitted in the form of a signal edge generated at a particular nominal time, in which method the following method steps are performed, namely:

a) detection of the times of occurrence of signal edges;

b) determination of edge intervals by means of the detected times of occurrence of signal edges.

The invention further relates to a communication station and data rate detection means suitable for performing such a method.

Such a communication station and data rate detection means suitable for implementing a method with the method steps described above for detecting a data rate in a data signal of an asynchronous data transmission system have been marketed by the applicants and are therefore known. In the known asynchronous data transmission system the expected data rate is normally known because the data rate is generated by a stable internal oscillator circuit of a data signal transmitter. Difficulties, however, arise when the data signal transmitter is formed using a semiconductor polymer, because then with the data signal transmitter there is no longer a data signal output with a stable data rate but only rather with a varying data rate, so that with the known routine, the routine steps described above can no longer be used to detect the data rate. This is because in said case because of the wide spread of individual components of the data signal transmitter made of a semiconductor polymer and because of a pronounced aging effect of these components, in the data signal transmitter the data rate occurring can have a fluctuation of up to 10% and the data rates of two different data signal transmitters can deviate from each other by a factor of one hundred (100).

It is an object of the invention to eliminate said problems and achieve an improved method and improved communication station and improved data rate detection means.

To achieve the object defined above in a method according to the invention features according to the invention are provided so that a method according to the invention can be characterized in the following manner, namely:

A method for detecting a data rate in a data signal of an asynchronous data transmission system in which system a bit is transmitted in the form of a signal edge generated at a particular nominal time, in which method the method steps described below are performed, namely:

a) detection of the times of occurrence of signal edges,

b) determination of edge intervals by means of the detected times of occurrence of signal edges,

c) determination of a mean edge interval by averaging the determined edge intervals

d) determination of a lower time of occurrence limit and an upper time of occurrence limit from the determined mean edge interval and a tolerance range of the determined mean edge interval in relation to a preceding signal edge, and

e) checking the occurrence of a subsequent signal edge in relation to the lower time of occurrence limit and the upper time of occurrence limit.

To achieve the object described above in a communication station according to the invention the features according to the invention are provided so that a communication station according to the invention can be characterized in the following manner, namely:

A communication station with data rate detection means for detecting a data rate in a data signal of an asynchronous data transmission system, in which system a bit is transmitted in the form of a signal edge generated at a particular nominal time, which data rate detection means contain the following means, namely:

a) detection means for detecting the times of occurrence of signal edges,

b) first determination means for determining edge intervals by means of the detected times of occurrence of signal edges,

c) second determination means for determining a mean edge interval by averaging the determined edge intervals,

d) third determination means for determining a lower time of occurrence limit and an upper time of occurrence limit from the determined mean edge interval and a tolerance range of the determined mean edge interval in relation to a preceding signal edge, and

e) check means for checking the occurrence of a subsequent signal edge in relation to the lower time of occurrence limit and the upper time of occurrence limit.

To achieve the object given above in a data rate detection means according to the invention features according to the invention are provided so that the data rate detection means according to the invention can be characterized as follows, namely

A data rate detection means to detect a data rate in a data signal of an asynchronous data transmission system, in which system a bit is transmitted in the form of a signal edge generated at a particular nominal time, which data rate detection means contain the following means namely:

a) detection means for detecting the times of occurrence of signal edges,

b) first determination means for determining edge intervals by means of the detected times of occurrence of signal edges,

c) second determination means for determining a mean edge interval by averaging the determined edge intervals,

d) third determination means for determining a lower time of occurrence limit and an upper time of occurrence limit from the determined mean edge interval and a tolerance range of the determined mean edge interval in relation to a preceding signal edge, and

e) check means for checking the occurrence of a subsequent signal edge in relation to the lower time of occurrence limit and the upper time of occurrence limit.

By the provision of features according to the invention in a simple manner with both a hard-wired logic circuit and with a programmable circuit, an improved method and an improved communication station and improved data rate detection means are obtained, a very important improvement being that with the method according to the invention varying data rates in a data signal can be detected which lie far above the previously detectable fluctuations of data rates. This particularly offers the advantage that in data transmission systems in which data signals are supplied from a data signal transmitter produced in polymer IC technology, in which considerable variations in the data rate occur in the data signals, an always perfect data communication to a communication station is guaranteed because perfect detection of the data rate is always ensured by means of the measures according to the invention, despite the varying data rate.

With a method according to the invention it has proved particularly advantageous if additionally the features as claimed in claim 2 or claim 3 or claim 4 or claim 5 are provided. This creates a method which can be implemented with particularly simple means.

In a method according to the invention it has proved particularly advantageous if also the features as claimed in claim 6 or claim 7 or claim 8 are provided, as here data rate detection is possible within a particularly wide data rate detection range, namely because of a particularly effective adaptation to rapid changes in the data rate.

In a method according to the invention the data rate can be detected via an “offline” determination which gives a reduced load on the programmable circuit, but with which no direct data rate detection is possible. It has proved particularly advantageous if in a method and a communication station and data rate detection means according to the invention also the features as claimed in claim 9 or claim 11 or claim 15 are provided while advantageously an “on-line” determination of the data rate is possible i.e. a direct data rate detection in real time.

The aspects described above and further aspects of the invention arise from the example of embodiment described below and are explained using this example of embodiment.

The invention will be further described with reference to two examples of embodiment shown in the drawings, to which however the invention is not restricted.

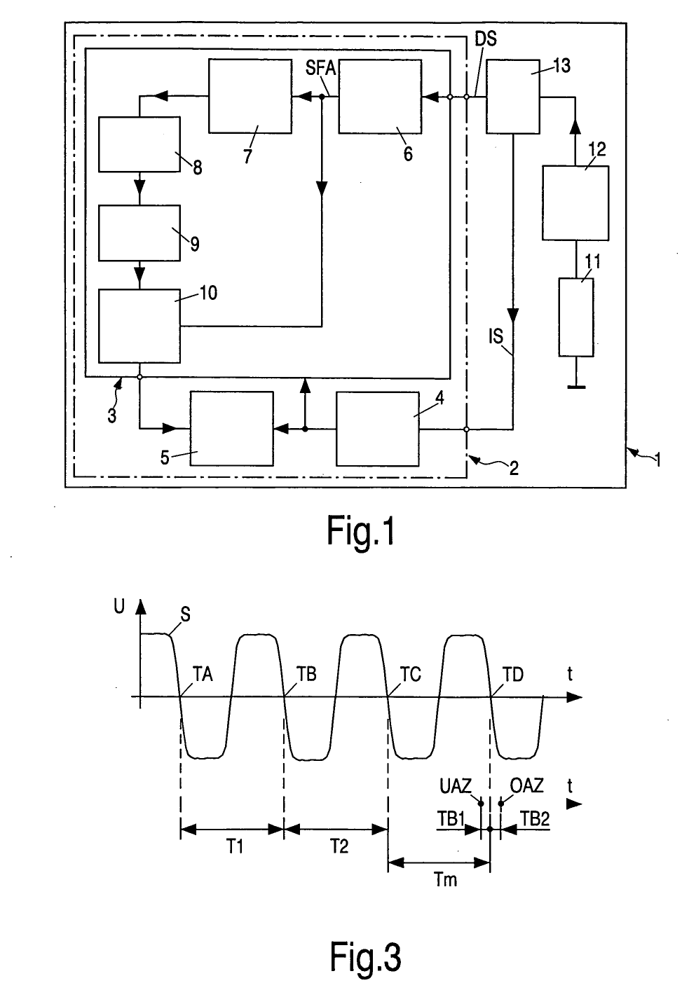

FIG. 1 diagrammatically shows in the form of a block circuit diagram a part essential for a communication station in the present context and data rate detection means according to a first example of embodiment of the invention.

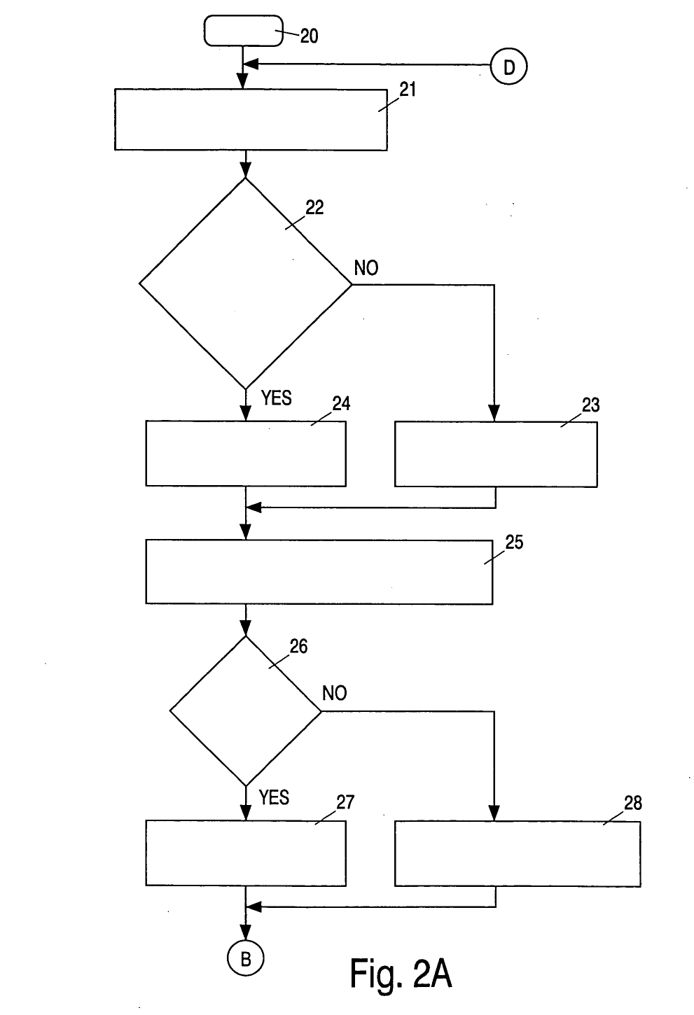

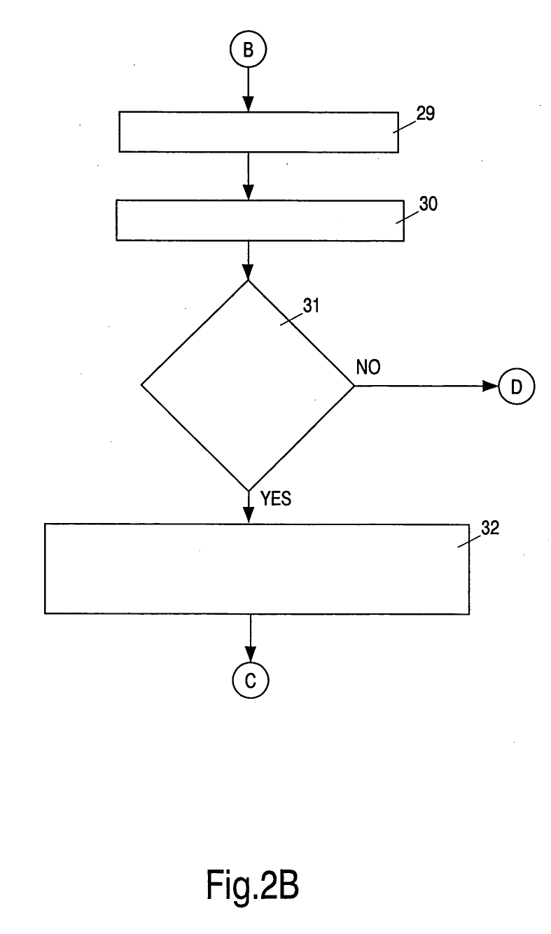

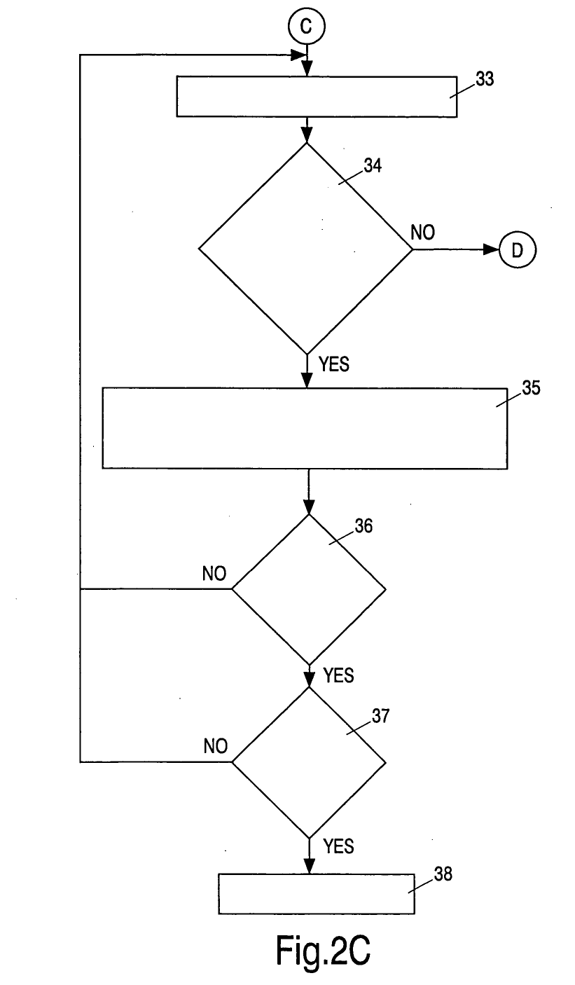

FIGS. 2A to 2C show a flow chart of a routine taking place in the communication station shown in FIG. 1 on performance of a method according to the invention.

FIG. 3 diagrammatically shows a data signal occurring in the communication station according to FIG. 1 and the time information obtained from this.

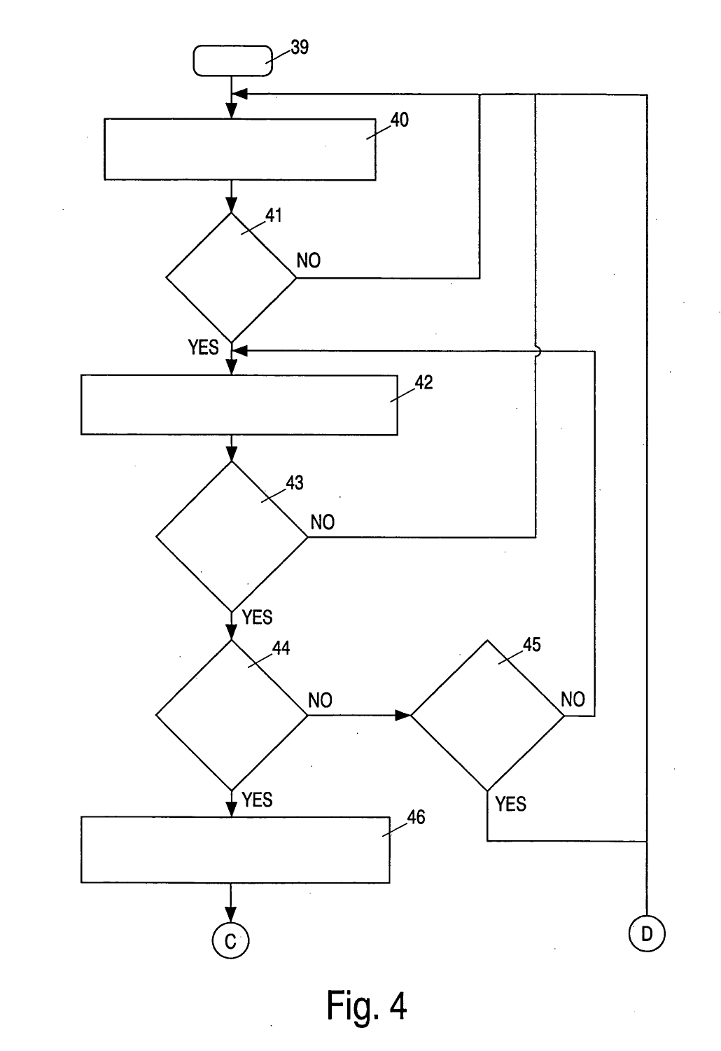

FIG. 4 shows part of a flow chart of a routine taking place in a communication station according to a second example of embodiment of the invention.

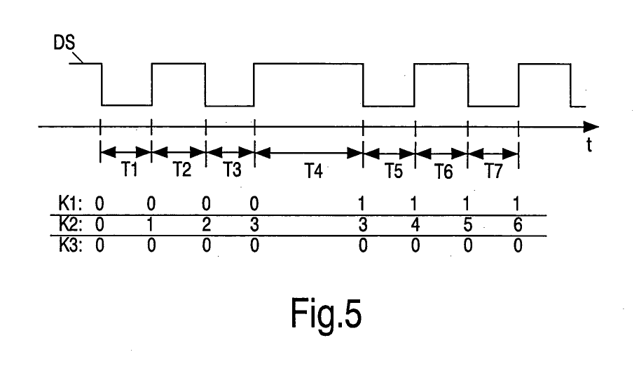

FIG. 5 diagrammatically shows a data signal occurring in the communication station according to FIG. 4 and the time information and class allocations obtained from this.

FIG. 1 shows a communication station 1. The communication station 1 contains a station circuit 2 formed in the present case by a microcomputer. It should be stated that the station circuit 2 can also be formed by a hard-wired logic circuit. The station circuit 2 contains a central processing unit (CPU) 4 and other components not shown but required for standard operation of a microcomputer, and station data processing means 5 controlled by the central processing unit (CPU) 4.

The station circuit 2 also contains data rate detection means 3 which are also controlled by the central processing unit (CPU) 4 and provided for performance of data rate detection. The data rate detection means 3 contains signal edge detection means 6 designed to detect signal edges, in the present case falling signal edges, and to generate signal edge occurrence information SFA. It should be stated that such signal edge detection means 6 are also designed to detect rising signal edges. The data rate detection means 3 also contain, connected after the signal edge detection means 6, first determination means 7 also known as edge interval determination means 7 which are designed to determine an edge interval from the signal edge occurrence signals SFA. The data rate detection means 3 also contains second determination means 8 intended to determine a mean edge interval from the edge intervals determined by the preceding edge interval determination means 7. The data rate detection means 3 also contain third determination means 9 connected downstream of the second determination means 8, and check means 10 connected downstream of the third determination means 9. The third determination means 9 are designed to determine a lower occurrence limit and an upper occurrence limit from the determined mean edge interval and a tolerance range of the determined mean edge interval in relation to a preceding signal edge, as will be explained in more detail below. The check means 10 are designed to check the occurrence of a subsequent signal edge in relation to the lower time of occurrence limit and the upper time of occurrence limit, in which the signal edge occurrence signal SFA is supplied to the check means 10.

The communication station 1 in the present case is part of an asynchronous data transmission system and is here designed for contactless communication with at least one data carrier not shown here. This contactless communication can take place for example at least partly according to standard ISO 14443. To this end the communication station 1 also has transmitter/receiver means 11 for transmitting and receiving data signals and demodulation means 12 connected with the transmitter/receiver means 11. The means required for transmission are not shown here because of their irrelevance in the present context. A demodulated data signal obtained using demodulation means 12 from said asynchronous data transmission system, in which system a bit is transmitted in the form of a signal edge generated at a particular nominal time, is supplied to an analog/digital converter stage 13 downstream of the demodulation means 12 and designed to generate a digital signal DS and an interrupt signal IS. The data signal DS is supplied to the signal edge detection means 6. The interrupt signal IS is formed after each analog/digital conversion in the analog/digital conversion stage 13 and supplied to the central processing unit (CPU) 4.

A procedure is described below which is performed in the data rate detection means 3 after activation by the central processing unit (CPU) 4 on the basis of an interrupt signal IS. FIGS. 2A to 2C show a routine in the form of a flow chart taking place in the communication station 1 according to FIG. 1, known as a “summation and comparison” routine. In principle it should be pointed out that the routine described can take place repeatedly in succession and that during the routine variables assume allocated values which can retain their validity in a subsequent routine.

As is clear from FIG. 2A the routine starts at a block 20. Then at a block 21 are detected the times of occurrence of signal edges, namely of falling signal edges, and edge intervals T are determined by means of the detected times of occurrence. As explanation reference should be made here to FIG. 3 which shows the times of occurrence TA, TB, TC, TD and a first edge interval T1 obtained from the times of occurrence TA and TB of signal edges of a data signal S, and in which a subsequent second edge interval T2 is shown which is obtained from the times of occurrence TB and TC of signal edges of data signal S. The times of occurrence of signal edges are preferably detected in the manner described in European Patent Application (not yet published) application number 01890215.5 and with the applicants' reference PHAT010045 EP-P, which is herewith incorporated by reference. It can be stated that to detect the times of occurrence of signal edges also other methods and means can be used which are known in specialist circles so they are not described in detail here.

After block 21, at a block 22 a decision query is made which checks whether the currently detected edge interval is greater than a previously detected maximum edge interval T_{M}. If the result of the decision query at block 22 is negative (NO), a routine operation is performed at block 23.

If the result of the decision query at block 22 is positive (YES), a routine operation is performed at block 24. At block 23 the maximum edge interval T_{M} is calculated from a maximum edge interval T_{M} determined in a previous routine according to a formula 1, where W₁ constitutes a first weighting factor:

T_{M}=T_{M}−T_{M}*W₁ (1)

At block 24 the maximum edge interval T_{M} is determined from the edge interval T determined at block 21 and a second weighting factor W₂ according to a second formula:

T_{M}=T−T*W₂+T_{M}*W₂ (2)

Both after block 23 and after block 24 the routine is continued in a block 25. In the block 25 the currently determined edge interval T is added to the previously determined edge interval T. At block 26 following block 25 it is checked whether the sum determined at block 25 is lower than a sum determined in a preceding routine of the “summation and comparison” routine. If the result at block 26 is negative (NO), the routine is continued in a block 28. If the result at block 26 is positive (YES), the routine is continued in a block 27.

At block 27 a sum minimum S_{MIN} is determined from the sum S determined at block 25 and a previously determined sum minimum S_{MIN} according to a formula 3, where W₃ represents a third weighting factor:

S_{MIN}=S−S*W₃+S_{MIN}*W₃ (3)

At block 28 the sum minimum S_{MIN} is formed from a previous sum minimum S_{MIN} and a fourth weighting factor W₄ according to the formula 4:

S_{MIN}=S_{MIN}−S_{MIN}*W₄ (4)

Both after block 27 and after block 28 the routine is continued at block 29 as is shown in FIGS. 2A and 2B, in both of which a transition point B is shown. At block 29 a calculation is performed of a mean edge interval Tm from the average of the sum minimum S_{MIN} determined at block 27 or 28 and the value of the maximum edge interval T_{M} determined at block 23 or 24. At block 30 following block 29 are formed both a lower time of occurrence limit UAZ from the mean edge interval Tm minus a first tolerance range TB1 of the mean edge interval and an upper time of occurrence limit OAZ from the mean edge interval Tm plus a second tolerance range TB2 of the mean edge interval Tm. In a block 31 following block 30, it is checked whether the sum minimum S_{MIN} and the value of the maximum edge interval T_{M} lie in a range between the upper time of occurrence limit OAZ and the lower time of occurrence limit UAZ. If the result at block 31 is negative (NO), the routine is restarted via the transition point D i.e. at block 21. If the result at block 31 is positive (YES), it continues at block 32. At block 32 a data rate is detected from the mean edge interval and each detected signal edge representing a bit in the asynchronous data transmission system is converted into a corresponding bit i.e. back conversion takes place of each bit transmitted by the data transmission system in the form of a signal edge generated at a particular nominal time.

Beyond a transition point C shown in FIGS. 2B and 2C, after block 32, the routine is continued at a block 33 as the partial routine shown in FIG. 2C. At block 33 the bits obtained at block 32 are collected and checked according to the communication protocol to be applied. After block 33 a decision query takes place at block 34 to check whether a current signal edge time of occurrence lies in the range between the upper time of occurrence limit OAZ and the lower time of occurrence limit UAZ. If the result of the decision query at block 34 is negative (NO), the routine begins again i.e. in this case after block 20 as is shown by the transition point D also shown in FIG. 2C. If the result of the decision query at block 34 is positive (YES), the routine continues at block 35.

At block 35 the current signal edge is converted into a bit and the received bit checked according to the communication protocol. In a decision query performed at block 36 after block 35, a validity of the bit data is checked. If the result of the decision query at block 36 is negative (NO), the routine is continued at block 33. If the result of the decision query at block 36 is positive (YES), then a decision query is made at block 37 which query makes a comparison of the obtained data with previously obtained data and checks for correlation. If the result at block 37 is negative (NO), the routine continues at block 33. If the result at block 37 is positive (YES), the routine continues at block 38 in which the obtained bits and hence the obtained data are passed to the station data processing means 5. It should be stated that the routine described here can also be successfully used without the decision query at block 37.

FIG. 4 shows in the form of a flow chart part of a routine taking place in a communication station according to a second example of embodiment of the invention, which can be called a “class allocation” routine.

As is clear from FIG. 4, the routine starts at block 39. Then at block 40 are detected the times of occurrence of signal edges, namely falling signal edges, and the edge intervals determined by means of the determined times of occurrence. Reference should again be made here to FIG. 3 for explanation, in analogy to the statements relating to FIG. 2A. It should be stated again here that detection of the times of occurrence of signal edges can be performed in the same legitimate manner for rising signal edges if desired. After block 40 a decision query is made at block 41 to check whether a first determination of an edge interval has been performed. If the result of the decision query at block 41 is negative (NO), the routine begins again i.e. continues at block 40. If the result of the decision query at block 41 is positive (YES), the routine continues at block 42.

At block 42 the edge intervals determined are categorized into a class, where a first determined edge interval is allocated to a middle class K2 which has a limit area which is formed by the first determined edge interval and a tolerance range of the middle class K2, and where a further determined edge interval is allocated either to a longer class K1 which has a limit area formed by double the first determined edge interval and the tolerance range of the longer class, or to a shorter class K3 which has a limit area formed by half the first determined edge interval and a tolerance range of the shorter class. In other words the classes are established using the first determined edge interval, where the middle class K2 is always formed from the first determined edge interval and the two further classes, namely a longer class K1 and a shorter class K3, are formed with double and half the first determined edge interval, respectively. According to the transmission protocol in the present example of embodiment, as expected i.e. the fault-free case long and short edge intervals occur. With regard to the categorizing of further determined edge intervals this means that only two of the classes are “filled”, where the two classes to be filled form a current pair of classes, namely always the middle class K2 and an additional class, where the additional class is formed by the shorter class K3 if the first determined edge interval was a long edge interval, and by the longer class K1 if the first determined edge interval was a short edge interval.

Following block 42, in a block 43 a decision query is made to check whether a signal edge has occurred. If the result of the decision query at block 43 is negative (NO), the routine continues at block 40 i.e. the routine begins again. If the result of the decision query at block 43 is positive (YES), the routine continues at block 44.

At block 44 it is checked whether a number A1 of allocated determined edge intervals lie in the middle class and a number A2 of determined edge intervals lie in the additional class of the current pair of classes. If the result of the decision query at block 44 is positive (YES), which is the case if for example four (4) determined edge intervals are contained in the middle class and one (1) edge interval in the additional class, the routine is continued at block 46. If the result of the decision query at block 44 is negative (NO), in a subsequent block 45 it is then checked whether a determined edge interval was allocated to a class not allocated to the current pair of classes i.e. either the longer class K1 or the shorter class K3, or not allocated to either of these classes. If the result of the check at block 45 is positive (YES), the routine continues at block 40 i.e. begins again. If the result of the check at block 45 is negative (NO), the routine continues at block 42.

At block 46 the data rate is detected from the determined edge intervals allocated to the classes and each detected signal edge representing a bit is converted to a corresponding bit i.e. there is back conversion of each bit transmitted by the data transmission system in the form of the signal edge generated at a particular nominal time. The routine according to FIG. 4 is then continued after block 46 beyond a transition point C shown in FIGS. 4 and 2C at block 33 of the part shown in FIG. 2C of the routine according to FIGS. 2A and 2B and 2C, which has already been described above in connection with the “summation and comparison” routine. In the present case, on a negative result (NO) to the decision query at block 34 of FIG. 2C, the routine is started again i.e. in this case continued at block 40, as is shown by the transition point D also shown in FIG. 4. To illustrate the class allocation or categorization of the determined edge intervals as described above, reference is made to a FIG. 5. FIG. 5 shows a data signal DS with temporally successive signal edges which are separated from each other by determined edge intervals T1, T2, T3, T4, T5, T6, T7. For example T1=100 ms, T2=104 ms, T3=95 ms, T4=204 ms, T5=98 ms, T6=101 ms, T7=96 ms. It is expressly stated that these time values given are merely examples and in principle can be replaced by any technically feasible and sensible time values, for example from nanoseconds to seconds and minute time values. K1, K2 and K3 are the classes as explained above, where the given figure values express the number of determined edge intervals allocated to the classes and referred to below as class values. The first edge interval T1 is allocated to the middle class K2, which is indicated by a corresponding change of the class value of class K2 from zero (0) to one (1). The limit area of the middle class K2 is determined using the first edge interval T1 and a tolerance range of the middle class K2, giving a so-called expectation value range EW2 of the middle class K2. On the assumption that the tolerance range of the middle class K2 has a value of ±10%, the expectation value range EW2 of the middle class K2 extends from 90 ms to 110 ms. For the longer class K1 formed from double the first edge interval T1 and the tolerance range of the longer class K1, and the shorter class K3 formed from half the first edge interval T1 and the tolerance range of the shorter class K3, for a tolerance range of the longer class K1 of ±5% and a tolerance range of the shorter class K3 of ±20%, the expectation value range EW1 of the longer class K1 is 190 ms to 210 ms and the expectation value range EW3 of the shorter class K3 is 40 ms to 60 ms. A subsequent second edge interval T2 is allocated to the class K2 as the time value of the second edge interval T2 lies in the expectation value range EW2 of the middle class K2. Accordingly the class value of the middle class K2 rises from two (2) to three (3). A following third edge interval T3 and T5, T6 and T7 are allocated to the middle class K2 in accordance with the routine described. Because of the time value of a fourth edge interval T4, this is allocated to the longer class K1 with a corresponding increase in class value of the longer class K1. It can be stated that to increase the accuracy and reliability of the “class routine”, the tolerance ranges of the classes can be changed i.e. adapted after each class allocation, for example calculated from a mean of two successive edge intervals allocated to the middle class K2.

1. A method for detecting a data rate in a data signal of an asynchronous data transmission system, in which asynchronous data transmission system a bit is transmitted in the form of a signal edge generated at a particular nominal time, the method comprising:
a) detection of the times of occurrence of signal edges;
b) determination of edge intervals by means of the detected times of occurrence of signal edges,
c) determination of a mean edge interval by averaging the determined edge intervals,
d) determination of a lower time of occurrence limit and an upper time of occurrence limit from the determined mean edge interval and a tolerance range of the determined mean edge interval in relation to a preceding signal edge, and
e) checking the occurrence of a subsequent signal edge in relation to the lower time of occurrence limit and the upper time of occurrence limit.

2. A method as claimed in claim 1, in which the determined edge intervals are averaged by means of class allocation.

3. A method as claimed in claim 2, in which a first determined edge interval is allocated to a middle class which has a limit area formed with the first determined edge interval and a tolerance range of the middle class, and in which a further determined edge interval is allocated either to a longer class which has a limit area formed by double the first determined edge interval and a tolerance range of the longer class, or to a shorter class which has a limit area formed by half the first determined edge interval and a tolerance range of the shorter class, and in which subsequently determined edge intervals are allocated to one of these classes.

4. A method as claimed in claim 3, in which the mean edge interval is formed from the mean of the determined edge intervals in the middle class and in the longer class if a specified number of determined edge intervals lie in the middle class and a further specified number of determined edge intervals lie in the longer class.

5. A method as claimed in claim 3, in which the mean edge interval is formed from the mean of the determined edge intervals in the shorter class and in the middle class if a specified number of determined edge intervals lie in the shorter class and a further specified number of determined edge intervals lie in the middle class.

6. A method as claimed in claim 1, in which the determined edge intervals are averaged by means of summation and comparison, while sums are formed from each two successive determined edge intervals, from which sums a minimum sum value is formed and a respective maximum value is formed from the determined edge intervals, and each time it is established whether the maximum value and the minimum sum value have a permitted value.

7. A method as claimed in claim 6, in which a specified number of maximum values of determined edge intervals is formed from the determined edge intervals and the same specified number of minimum sum values are formed from two successive determined edge intervals, and in which a mean value of the maximum values is formed from the specified number of maximum values, and in which a mean value of the minimum sum value is formed from the specified number of minimum sum values, and in which the mean edge interval is formed from the mean of the maximum values and the mean of the minimum sum values if the specified number of maximum values lie within a tolerance range of the maximum value and the mean of the maximum values and the specified number of minimum sum values lie within a tolerance range of the minimum sum values and the mean of the minimum sum values.

8. A method as claimed in claim 6, in which the minimum sum values are weighted from the sum of two successive determined edge intervals and the maximum values, in which a minimum peak value is determined from the minimum sum values and a maximum peak value is determined form the maximum values, and in which a new minimum peak value is weighted with a first weighting factor and furthermore a second weighting factor is deducted from the new minimum peak value, and in which a mean of the minimum peak values is determined and a mean of the maximum peak values is determined, and in which the mean edge interval is formed from the mean of the minimum peak values and the mean of the maximum peak values if the minimum peak values lie within a tolerance range of the minimum peak value around the mean of the minimum peak values and the maximum peak values lie within a tolerance range of the maximum peak value around the mean of the maximum peak values.

9. A method as claimed in claim 1, in which an analog/digital conversion of the data signal is performed before detection of the times of occurrence of signal edges during which analog/digital conversion an interrupt signal is generated with which a direct performance of the method may be triggered.

10. A communication station comprising data rate detection means for detecting a data rate in a data signal of an asynchronous data transmission system, in which system a bit is transmitted in the form of a signal edge generated at a particular nominal time, which data rate detection means comprises:
a) detection means for detecting the times of occurrence of signal edges,
b) first determination means for determining edge intervals by means of the detected times of occurrence of signal edges,
c) second determination means for determining a mean edge interval by averaging the determined edge intervals,
d) third determination means for determining a lower time of occurrence limit and an upper time of occurrence limit from the determined mean edge interval and a tolerance range of the determined mean edge interval in relation to a preceding signal edge, and
e) check means for checking the occurrence of a subsequent signal edge in relation to the lower time of occurrence limit and the upper time of occurrence limit.

11. A communication station as claimed in claim 10, in which analog/digital conversion means are provided which, after analog/digital conversion of the data signal, can generate an interrupt signal with which direct detection of a data rate can be triggered with the data rate detection means.

12. Data rate detection means for detecting a data rate in a data signal of an asynchronous data transmission system, in which system a bit is transmitted in the form of a signal edge generated at a particular nominal time, which data rate detection means comprises:
a) detection means for detecting the times of occurrence of signal edges,
b) first determination means for determining edge intervals by means of the detected times of occurrence of signal edges,
c) second determination means for determining a mean edge interval by averaging the determined edge intervals,
d) third determination means for determining a lower time of occurrence limit and an upper time of occurrence limit from the determined mean edge interval and a tolerance range of the determined mean edge interval in relation to a preceding signal edge, and
e) check means for checking the occurrence of a subsequent signal edge in relation to the lower time of occurrence limit and the upper time of occurrence limit.

13. Data rate detection means as claimed in claim 12, in which the second determination means are designed to perform an averaging of the determined edge intervals by means of class allocation.

14. Data rate detection means as claimed in claim 12, in which the second determination means are designed to perform an averaging of the determined edge intervals by means of summation and comparison.

15. Data rate detection means as claimed in claim 12, in which analog/digital conversion means are provided which can generate an interrupt signal after analog/digital conversion of the data signal with which interrupt signal a direct detection of a data rate with the data rate detection means can be triggered.
